(19) United States
(12) Patent Application Publication
(10) Pub. No.: US 2023/0148776 A1
(43) Pub. Date: May 18, 2023

(54) Boiled Egg Handheld Peeler and a Method of Use Thereof

(71) Applicant: Leonard Otto, Inez, TX (US)

(72) Inventor: Leonard Otto, Inez, TX (US)

(21) Appl. No.: 17/946,197

(22) Filed: Sep. 16, 2022

Related U.S. Application Data
(60) Provisional application No. 63/279,350, filed on Nov. 15, 2021.

(51) Int. Cl. A47G 19/28; A47G 21/00; A23L 15/00

(52) U.S. Cl. CPC A47G 19/28; A47G 21/00; A23L 15/00; A23V 2002/00

(57) ABSTRACT

The present invention relates to a handheld tool to facilitate removing of an eggshell from a hard-boiled egg quickly and safely without damaging the egg and creating a mess. The tool includes a longitudinally extending handle, a peeler portion having a top concave surface and a bottom convex surface, a fin protrusion attached to the bottom convex surface, and a neck positioned between the handle and the peeler portion. The fin protrusion is used for tapping the eggshell of the hard-boiled egg to crack the eggshell and the peeler portion is configured to insert underneath the eggshell and to move along an exterior of the hard-boiled egg for removing the eggshell therefrom. The tool removes the eggshell quickly within ten seconds without breaking the eggshell into tiny pieces.

### CROSS-REFERENCE TO RELATED APPLICATION

The present application claims priority to, and the benefit of, U.S. Provisional Application No. 63/279,350, which was filed on Nov. 15, 2021 and is incorporated herein by reference in its entirety.

### FIELD OF THE INVENTION

The present invention relates generally to the field of eggs and peeling devices. More specifically, the present invention relates to a boiled egg peeler handheld tool for quickly and easily removing shells of hard-boiled eggs. The handheld tool has a peeler portion, having a concave top surface and a fin protrusion on the bottom surface. The fin is tapped on the eggshell to crack the shell and the peeler portion is inserted underneath the shell to peel the shell from the exterior surface of the hard-boiled egg. Accordingly, the present disclosure makes specific reference thereto. Nonetheless, it is to be appreciated that aspects of the present invention are also equally applicable to other like applications, devices, and methods of manufacture.

### BACKGROUND

By way of background, eggs are an important nutritional product and routinely consumed by people. Hard cooked, hard-boiled, peeled, and packaged eggs are becoming increasingly popular in the institutional food service, in the food industry, and in retail marketing. Numerous advantages are connected with the use of the hard-boiled eggs, such as providing nutrition and protein, good taste, colorfulness, long shelf life, ease of preparation, and low cost, among other advantages.

Removing and peeling shells of hard-boiled eggs is a difficult and tedious process. Commercially, peeling machines are used for easily and quickly peeling the shells but such machines are not designed to be used at homes where a small number of hard-boiled eggs are required to be peeled. Further, such machines are large in size and are expensive and are designed for the egg industry and retail industry.

At homes, small restaurants and/or cafes, shells of hard-boiled eggs are peeled using a person's fingers. Conventionally, a hard-boiled egg is cracked by hitting with a utensil or hitting the egg on a surface. Then, the shell is removed using fingers that may break the shell into pieces and further, peeling of the shell of the boiled egg can result in crumbled pieces of the shell that can damage the egg. Peeling shells of fresh eggs represents more of a challenge than older eggs due to air space between the shell and the white of the egg. Further, this conventional method is not only ineffective but also time consuming. People desire an egg peeling device that can be easily and safely used for peeling shells of hard-boiled eggs safely and conveniently.

Therefore, there exists a long-felt need in the art for an egg peeler device that can easily remove the shell of a hard-boiled egg. There is also a long-felt need in the art for a handheld egg peeler device that is cost-effective, portable, and easy to use. Additionally, there is a long-felt need in the art for an egg peeler device that does not damage the egg and prevents the shell from breaking into tiny pieces during the process of removing the shell. Moreover, there is a long-felt need in the art for a boiled egg peeler that can be used for quickly removing eggshells. Further, there is a long-felt need in the art for a boiled egg peeler tool that can obviate the requirement of using multiple kitchen tools or using fingers to remove eggshells. Finally, there is a long-felt need in the art for a handheld egg peeler device that offers a way to prevent eggshells from breaking into tiny pieces and making a mess while not damaging the egg white.

The subject matter disclosed and claimed herein, in one embodiment thereof, comprises a handheld hard-boiled egg peeler apparatus. The peeler apparatus provides a unique kitchen utensil for quickly removing hard-boiled eggshells, and without breaking the shell into tiny pieces. The peeler apparatus comprises a spoon-like peeler portion; a longitudinally extending handle; and a curved neck positioned between said peeler portion and said handle. The peeler portion is comprised of a concave top surface and a convex bottom surface, and a fin protrusion attached to the bottom convex surface. The peeler portion extends from a base to a proximal end, wherein the proximal end is narrower than the base. The fin protrusion is configured to tap on a hard-boiled eggshell to crack the shell, and the peeler portion is configured to remove the cracked shell when inserted underneath the cracked shell and moved along the exterior surface of the egg white of the hard-boiled egg to separate the shell from the egg white when the egg is positioned with the large end up.

In this manner, the handheld hard-boiled egg peeler apparatus of the present invention accomplishes all of the foregoing objectives and provides users with an improved egg peeler device for removing hard-boiled eggshells quickly, easily, and without creating mess. The apparatus can be used at homes or remotely anywhere and can provide a quick and easy-to-implement solution to egg peeling.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a handheld hard-boiled egg peeler apparatus. The peeler apparatus further comprising a peeler portion, a longitudinally extending handle, a curved neck positioned between said peeler portion and said handle, the peeler portion having a top concave surface and a bottom convex surface, a fin protrusion attached to the bottom convex surface, the peeler portion extending from a base to a distal end wherein the distal end is narrower than the base, said fin protrusion is configured to tap on hard-boiled eggshell to crack the shell and the peeler portion is configured to remove the cracked shell when inserted underneath the cracked shell and moved therebetween to separate the shell from the egg white.

In yet another embodiment, the apparatus is made from dishwasher safe food grade material.

In yet another embodiment, the apparatus is made from metal coated plastic.

In yet another embodiment, the peeler portion has a smooth edge that has obliquely slanted bends or sides at opposite ends of the base of the peeler portion.

In yet another embodiment, the top concave surface of the peeler portion conforms to the shape of the egg.

In yet another embodiment, a method of removing a shell of a hard-boiled egg is disclosed. The method includes the steps of providing a handheld spoon-like egg peeler device, the peeler device includes a peeler portion having a top concave surface and a bottom convex surface, a fin protrusion integrally attached to the bottom convex surface, a handle attached to a neck positioned between the peeler portion and the handle; holding a hard-boiled egg with the large end up; tapping the fin protrusion on the shell of the egg for cracking the shell; inserting the peeler portion underneath the shell; and peeling the shell to remove the shell without damaging the egg white while preventing the shell from breaking into tiny pieces.

In yet another embodiment, the method further includes removing the eggshell within ten seconds.

In yet another embodiment, a boiled egg peeler kitchen tool is disclosed. The kitchen tool is made of a dishwasher food safe material and includes a spoon like peeler portion with a fin attached underneath. A longitudinally extending handle is used for gripping the tool while peeling a boiled egg wherein the shell of the egg is tapped with the fin to crack the shell and the peeler portion is inserted underneath the shell and moved between the shell and the egg white of the hard-boiled egg to remove the shell.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one potential embodiment of an egg peeler handheld device of the present invention in accordance with the disclosed architecture;

FIG. 2 illustrates a bottom perspective view of the egg peeler handheld device of the present invention in accordance with the disclosed architecture;

FIG. 3 illustrates a perspective view showing cracking of a shell of a hard-boiled egg using the egg peeler device of the present invention in accordance with the disclosed architecture;

FIG. 4 illustrates a perspective view showing the peeling of the shell of the hard-boiled egg using the peeler portion of the peeler device of the present invention in accordance with the disclosed architecture; and

FIG. 5 illustrates a flow diagram illustrating steps performed in using the handheld egg peeler apparatus of the present invention for separating the shell from the egg white of hard-boiled eggs in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an egg peeler device that can easily remove the shell of a hard-boiled egg. There is also a long-felt need in the art for a handheld egg peeler device that is cost-effective, portable, and easy to use. Additionally, there is a long-felt need in the art for an egg peeler device that does not damage the egg and prevents the shell from breaking into tiny pieces during the process of removing the shell. Moreover, there is a long-felt need in the art for a boiled egg peeler that can be used for quickly removing eggshells. Further, there is a long-felt need in the art for a boiled egg peeler tool that obviates the requirement of using multiple kitchen tools or using fingers to remove eggshells. Finally, there is a long-felt need in the art for a handheld egg peeler device that offers a way to prevent eggshells from breaking into tiny pieces and making a mess while not damaging the egg white.

The present invention, in one exemplary embodiment, is a method of removing shells of a hard-boiled eggs. The method includes the steps of providing a handheld, spoon-like egg peeler device, the peeler device includes a peeler portion having a top concave surface and a bottom convex surface, a fin protrusion integrally attached to the bottom convex surface, a handle attached to a neck positioned between the peeler portion and the handle; holding a hard-boiled egg with the large end up; tapping the fin protrusion on the shell of the egg for cracking the shell; inserting the peeler portion underneath the shell; and peeling the shell to remove the shell without damaging the egg white while preventing the shell from breaking into tiny pieces.

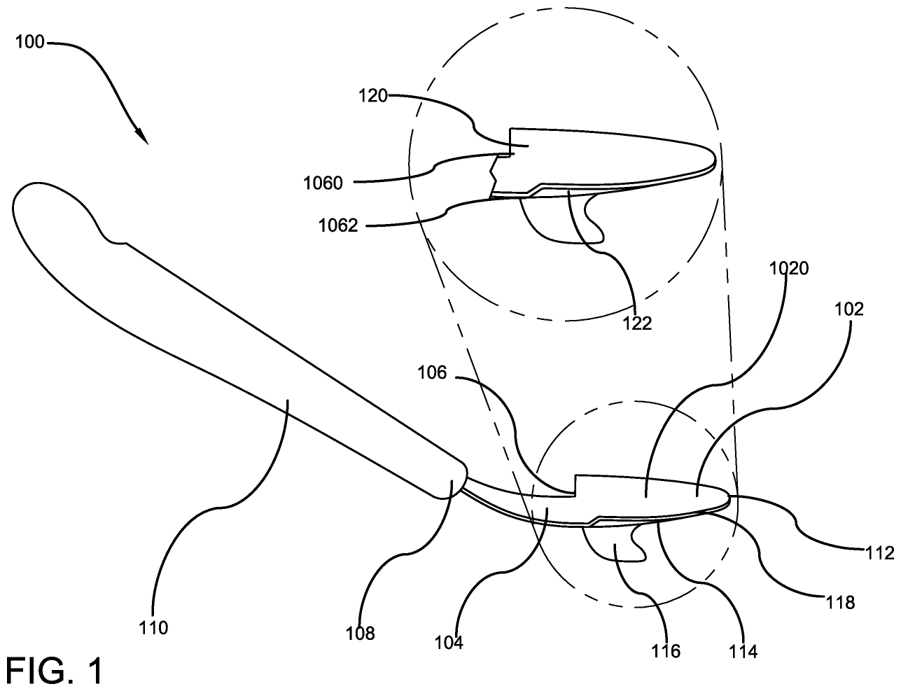

Referring initially to the drawings, FIG. 1 illustrates a perspective view of one potential embodiment of an egg peeler handheld device of the present invention in accordance with the disclosed architecture. The egg peeler handheld device 100 of the present invention is designed as a unique spoon-like kitchen utensil for removing hard-boiled eggshells easily and conveniently without damaging eggs. More specifically, the device 100 has a concave peeler portion 102 having a slight concave top surface 1020 that conforms to the shape and contour of an egg. The peeler portion 102 has an extended neck portion 104 wherein the neck portion 104 extends from the base 106 of the peeler portion 102 to a distal end 108 of a longitudinally extending handle 110. The handle 110 is used for gripping the device 100 during use and has an ergonomic construction. The handle 110 can be made of wood, plastic, lightweight metal, or any other similar material.

The distal end 112 of the peeler portion 102 is narrower than the base 106, providing an adequate surface for undergoing and peeling a broken shell without damaging the egg. The convex bottom surface 114 of the peeler portion 102 has a fin protrusion 116 used for cracking a hard-boiled eggshell. The fin protrusion 116 is solid and sturdy and makes an impact on the shell of a hard-boiled egg such as when the egg hits on a hard surface.

As illustrated, the neck portion 104 is narrower than the base 106 of the peeler portion 102 and is slightly curved allowing the fin 116 to be easily accommodated when the device 100 is placed on a surface with the concave top surface 1020 upwards. A curvilinear outer edge 118 of the peeler portion 102 is smoothly curved and has obliquely upward bends or sides 120, 122 on the opposite ends 1060, 1062 of the base 106. The bends or sides 120, 122 allow easy scraping and removal of the eggshell without penetrating into the egg white.

The length of the peeler portion 102 extending from the distal end 112 to the base 106 is from about 2 cm to about 4 cm. The distal end 112 may have a width of about 20-40% of the width of the base 106. The fin protrusion 116 is integrally molded to the convex surface 114, extends generally orthogonal thereto, and can have a thickness from about 0.3 cm to about 0.7 cm.

The egg peeler device 100 is preferably made of a dishwasher safe food grade material such as cutlery stainless steel, plastic, or other metal or alloy as commonly used in manufacturing eating utensils. It is also contemplated that the device 100 can be made of hard plastic with a metallic coating.

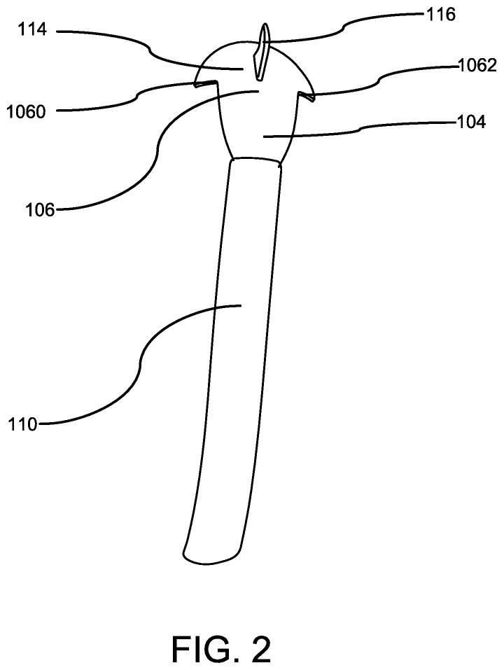

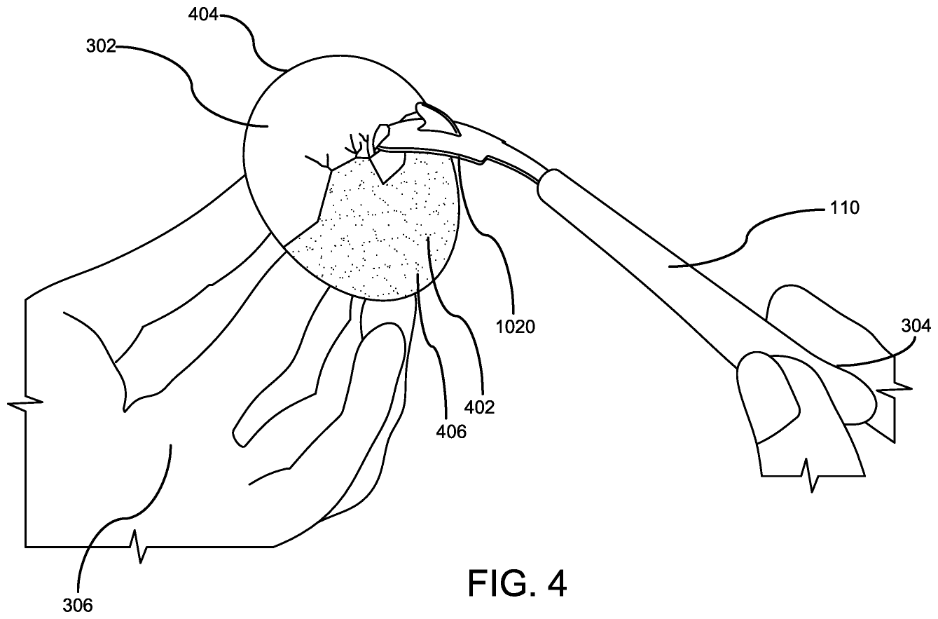

FIG. 2 illustrates a bottom perspective view of the egg peeler handheld device of the present invention in accordance with the disclosed architecture. The handle 110 can be molded to the neck 104 in one exemplary embodiment. Alternatively, the handle 110 can be removably attached to the neck 104 and the neck can have a groove to secure the handle 110. The fin 116 is preferably aligned with the handle and is positioned along the base 106 of the peeler portion 102. The neck 104 and the peeler portion 102 together form a shape like that of an arrow having concave top surface as described in FIG. 1 enabling the peeler portion 102 to conform to the shape of an egg and therefore easily inserting the peeler portion 102 underneath the shell of a hard-boiled egg and moving the peeler portion between the shell and the egg white of the hard-boiled egg as shown in FIG. 4.

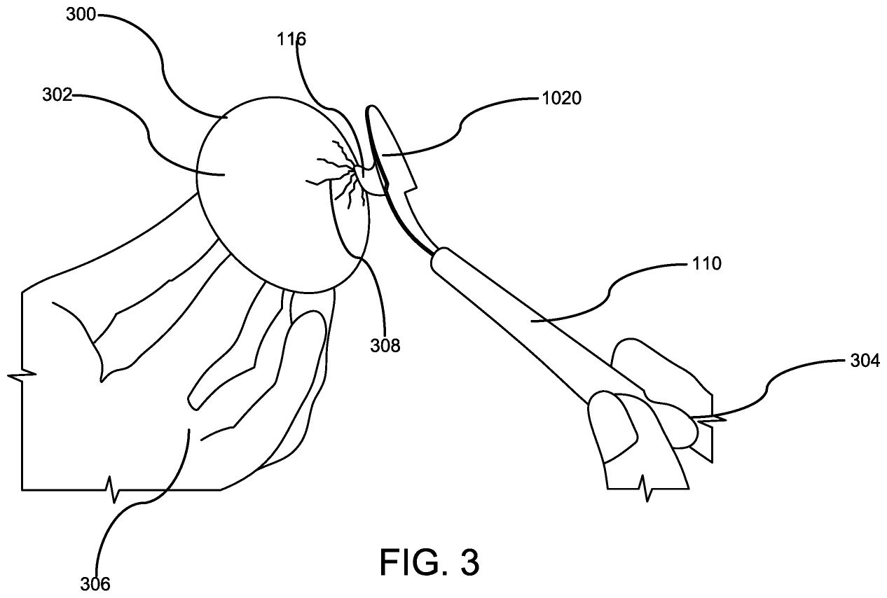

FIG. 3 illustrates a perspective view showing cracking of the shell of a hard-boiled egg using the egg peeler device of the present invention in accordance with the disclosed architecture. As illustrated, for safely cracking the shell 302 of a hard-boiled egg 300, the device 100 is held in one hand 304 using the handle 110 and the egg 300 is held in other hand 306. The egg 300 can alternatively be placed on any surface for cracking using the device 100. The device 100 is positioned such that the concave top surface 1020 of the peeler portion 102 faces upwards and the fin protrusion 116 faces the eggshell 302. The shell 302 is tapped lightly with the fin 116 and as a result, the shell 302 is cracked as shown through the numeral 308.

The shell 302 can be tapped at multiple places with the fin 116 depending on preferences of a user. Using the device 100 to crack the shell 302 of the hard-boiled egg 300 eliminates the process of hitting the egg 300 on a surface that can damage the egg.

FIG. 4 illustrates a perspective view showing the peeling of a shell of a hard-boiled egg using the peeler portion of the peeler device of the present invention in accordance with the disclosed architecture. After cracking the shell 302 using the fin 116 as described in FIG. 3, the peeler portion 102 is used for peeling the cracked shell. More specifically, the egg 300 is held such that the large end 404 of the egg 300 is placed up and the small end 406 of the egg 300 is positioned down. The concave surface 1020 of the peeler portion 102 is faced downward towards the egg 300 and the distal end 112 of the peeler 102 is inserted slightly underneath the cracked shell 302 to separate the shell 302 from the egg white 402. The peeler portion 102 is moved along the egg white 402 between the shell 302 and the egg 300 to peel the shell 302 without damaging the egg and without breaking the shell 302 into tiny pieces. The concave surface 1020 conforms to the shape of the egg 300 during the peeling process and therefore, does not damage the egg 300.

Repeating the process of inserting the peeler portion 102 underneath the shell 302 leads to peeling of the shell easily and conveniently to expose the egg white 402.

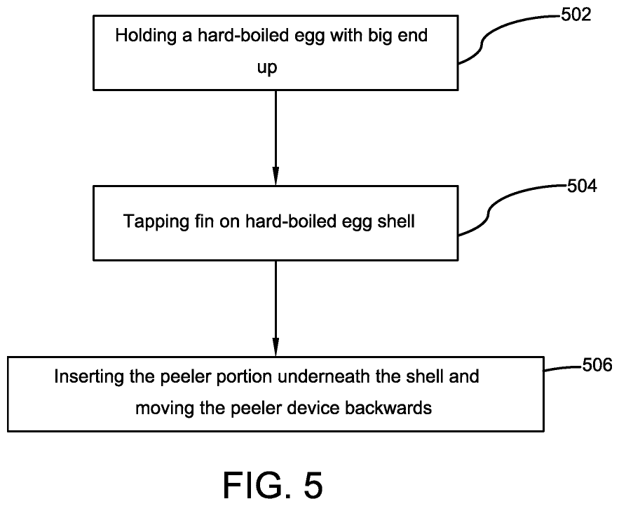

FIG. 5 illustrates a flow diagram illustrating steps performed in using the handheld egg peeler apparatus of the present invention for separating a shell from the egg white of hard-boiled egg in accordance with the disclosed architecture. Initially, a user holds a boiled egg 300 in a position in which the large end 404 of the egg 300 is positioned in an upward orientation (Step 502). Then, a user taps the fin protrusion 116 on the eggshell 302 to crack the shell (Step 504). The fin 116 can be tapped at a plurality of positions on the eggshell 302. Then, the peeler portion 102 is inserted underneath the cracked shell 308 and moved between the eggshell 302 and the egg white 402 to remove the shell 302 without breaking it into tiny pieces (Step 506). During movement, the smooth edge of the peeler portion 102 gently scrapes the egg white 402 without damaging the egg white 402. The eggshell 302 of a hard-boiled egg 300 is removed in less than ten seconds using the mentioned process.

The egg peeler device 100 of various embodiments of the present invention allows users to remove eggshells 302 safely and easily in less than ten seconds and offers a way to prevent shells 302 from breaking into tiny pieces and making a mess. The handheld egg peeler apparatus 100 provides a low-cost, readily portable solution for the peeling of hard-boiled eggs 300. The apparatus is configured to peel the eggs 300, separate the shell 302 from the egg white 402, and perform this process in a very short time cycle.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “egg peeler device”, “handheld egg peeler apparatus”, “device”, and “egg peeler handheld device” are interchangeable and refer to the handheld egg peeler apparatus 100 of the present invention.

Notwithstanding the foregoing, the handheld egg peeler apparatus 100 of the present invention can be of any suitable size and configuration as is known in the art without affecting the overall concept of the invention, provided that it accomplishes the above-stated objectives. One of ordinary skill in the art will appreciate that the handheld egg peeler apparatus 100 as shown in the FIGS. are for illustrative purposes only, and that many other sizes and shapes of the handheld egg peeler apparatus 100 are well within the scope of the present disclosure. Although the dimensions of the handheld egg peeler apparatus 100 are important design parameters for user convenience, the handheld egg peeler apparatus 100 may be of any size that ensures optimal performance during use and/or that suits the user's needs and/or preferences. All dimensions are inclusive.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An egg peeler comprising:
a peeler portion having a base, a concave top surface conforming to a shape and contour of an egg, and a convex bottom surface;
a handle having a gripping surface; and
a neck portion that extends from the base of said peeler portion to the handle, wherein said peeler portion further comprises a distal end that is narrower than said base, and further wherein said convex bottom surface comprises a fin protrusion extending generally orthogonally therefrom for cracking a shell of said egg.

2. The egg peeler of claim 1, wherein said neck portion is narrower than said base of said peeler portion.

3. The egg peeler of claim 1, wherein said neck portion curves upward from said handle to said base of said peeler portion.

4. The egg peeler of claim 1, wherein said peeler portion comprises a curvilinear outer edge having opposing upward extending sides.

5. The egg peeler of claim 1, wherein said peeler portion comprises a length extending from said distal end to said base that is between 2 cm and 4 cm, inclusive.

6. The egg peeler of claim 1, wherein said distal end of said peeler portion comprises a width that is between 20% and 40% of a width of said base.

7. The egg peeler of claim 1, wherein said fin protrusion comprises a thickness of between 0.3 cm and 0.7 cm, inclusive.

8. The egg peeler of claim 1, wherein said fin protrusion is aligned with said handle.

9. The egg peeler of claim 1, wherein said peeler portion is comprises of a material selected from a group consisting of a cutlery stainless steel, a plastic and a metal.

10. The egg peeler of claim 1, wherein said handle is comprised of a material selected from a group consisting of a wood, a plastic and a metal.

11. An egg peeler comprising:
a peeler portion having a concave top surface conforming to a shape and contour of an egg and a convex bottom surface;
a neck portion extending from a base of said peeler portion to a longitudinally extending handle;
wherein said handle provides a gripping surface during use of said egg peeler;
wherein said peeler portion includes a distal end narrower than said base;
wherein said neck portion is narrower than said base of said peeler portion;
wherein said neck portion curves upward from said handle to said base of said peeler portion; and
wherein said peeler portion includes a curvilinear outer edge having opposing upward extending sides.

12. The egg peeler of claim 11, wherein said convex bottom surface includes a fin protrusion extending generally orthogonally therefrom for cracking a hard-boiled eggshell.

13. The egg peeler of claim 11, wherein said peeler portion comprises a length extending from said distal end to said base of between 2 cm and 4 cm, inclusive.

14. The egg peeler of claim 11, wherein said distal end of said peeler portion comprises a width of between 20% and 40% of a width of said base.

15. The egg peeler of claim 12, wherein said fin protrusion comprises a thickness of between 0.3 cm and 0.7 cm, inclusive.

16. The egg peeler of claim 15, wherein said fin protrusion is aligned with said handle.

17. A method of peeling an eggshell from a hard-boiled egg using a handheld egg peeler, the method comprising the steps of:
holding a hard-boiled egg with a large end of the egg in an upward orientation;
cracking the eggshell in at least one position with a fin protruding from a peeler portion of said handheld egg peeler;
inserting said peeler portion between the cracked eggshell and the egg; and
moving said peeler portion between an outer surface of the egg and the eggshell for removing the eggshell.

18. The method of claim 17, wherein said peeler portion comprises a concave top surface conforming to a shape and contour of the hard-boiled egg and a convex bottom surface.

19. The method of claim 18, wherein said peeler portion comprises a distal end that is narrower than a base of said peeler portion.

20. The method of claim 18, wherein said fin extends generally orthogonally from said convex bottom surface for cracking the eggshell of the hard-boiled egg.
